(19) United States
(12) Patent Application Publication
(10) Pub. No.: US 2009/0061037 A1
(43) Pub. Date: Mar. 5, 2009

(54) Deivce for fabricating tubular containers

(76) Inventor: Engelbert Sander, Vouvry (CH)

Correspondence Address: NIXON & VANDERHYE, PC, 901 NORTH GLEBE ROAD, 11TH FLOOR, ARLINGTON, VA, 22203, US

(21) Appl. No.: 11/990,433

(22) PCT Filed: Aug. 16, 2006
(86) PCT No.: PCT/IB2006/052833

§ 371 Date: Apr. 22, 2008

(30) Foreign Application Priority Data
Sep. 9, 2005 (EP) 05108285.7

(51) Int. Cl. B29C 53/00; B65D 6/28; B65B 9/00

(52) U.S. Cl. 425/326.1; 220/613; 53/459

(57) ABSTRACT

Device for fabricating tubular containers made from plastics material and consisting of three distinct elements, namely a flexible tubular body, a rigid base, a top part including a neck, the said device comprising a mandrel and means for fixing a top part and a base to a flexible tubular body, characterized in that it consists of at least one fabrication unit comprising a support shaft having a free end provided with a retaining member adapted to prevent the movement of a container base in one direction, a tubular sleeve mounted slidably around the support shaft and having a free end located on the same side as the free end of the support shaft, a member for driving the tubular sleeve, and a space adapted for the relative movement of a tubular body around the tubular sleeve, the said tubular sleeve additionally comprising a top part grip member located near the free end of the sleeve, the said top part grip member comprising means for the instantaneous fixing and retention of an assembly consisting of a top part and a base of a container.

### TECHNICAL FIELD

The present invention relates to the field of tubular containers made from plastics material, which consist of three distinct elements, namely a flexible tubular body, a rigid base and a top part including a neck.

More specifically, the invention relates to a device and a method for producing these containers.

### PRIOR ART

There are various known devices for producing containers as described in the preceding section.

Briefly, such a device comprises a first type of mandrel which supports the tubular body and on which the top part which contains the neck is fixed. The assembly consisting of these two elements is then directed to a second type of mandrel on which the base is fixed.

However, the prior art devices are relatively complicated in respect of their structure. Furthermore, the transfer of a container during its formation from one type of mandrel to the other considerably lengthens the container fabrication time. The positioning of the base and/or top part is also difficult to achieve.

Thus there is a need to simplify the prior art devices and to decrease the container fabrication time.

### GENERAL OUTLINE OF THE INVENTION

The problem to be resolved by the present invention consists of the relative complexity of the prior art devices and the relatively long container fabrication times.

In the invention, the solution of the aforesaid problem consists in using only one type of mandrel for simultaneously fixing the top part and the base to the tubular body.

More precisely, the device according to the invention comprises a mandrel and means for fixing a top part, including a neck, and a base to a flexible tubular body. The device is characterized in that it consists of at least one fabrication unit comprising a support shaft having a free end provided with a retaining member adapted to prevent the movement of a container base in one direction, a tubular sleeve mounted slidably around the support shaft and having a free end located on the same side as the free end of the support shaft, a member for driving the tubular sleeve in a linear way, and a space adapted for the relative movement of a tubular body around the tubular sleeve, the said tubular sleeve additionally comprising a top part grip member located near the free end of the sleeve, the said top part grip member comprising means for the instantaneous fixing and retention of an assembly consisting of a top part and a base of a container.

The top part grip member can be of any type. In one embodiment of the invention, the fixing and retaining means consist of a screw thread.

Advantageously, the member for driving the tubular sleeve is of the pneumatic type, but any other appropriate type of drive can be used.

The device preferably comprises a plurality of fabrication units.

In one embodiment, the fabrication units are positioned along a circle.

In a variant of the invention, the top part and the base are initially fixed to each other, enabling them to be introduced into the device in a single operation.

The initial fixing of the base to the top part also provides other advantages. The assembly formed in this way is more rigid than the base on its own, and this increases the stability of the base when it is welded to the tubular body.

On the other hand, if the base were not initially fixed to the top part, it would have to be reinforced, for example by adding lateral fins. This would make the base heavier, more difficult to produce and therefore more costly.

### DETAILED DESCRIPTION OF THE INVENTION

The invention is described more fully below with the aid of examples illustrated by the following figures:

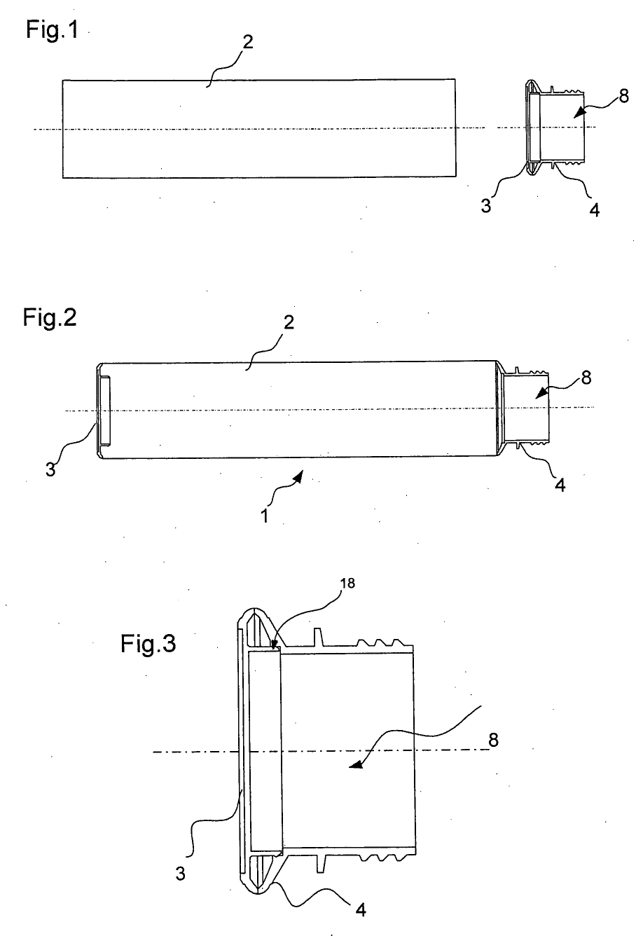

FIG. 1 shows the separate elements of a container which can be used with the device according to the invention.

FIG. 2 shows the elements of the figure when they are assembled.

FIG. 3 shows an assembly consisting of a base and a top part.

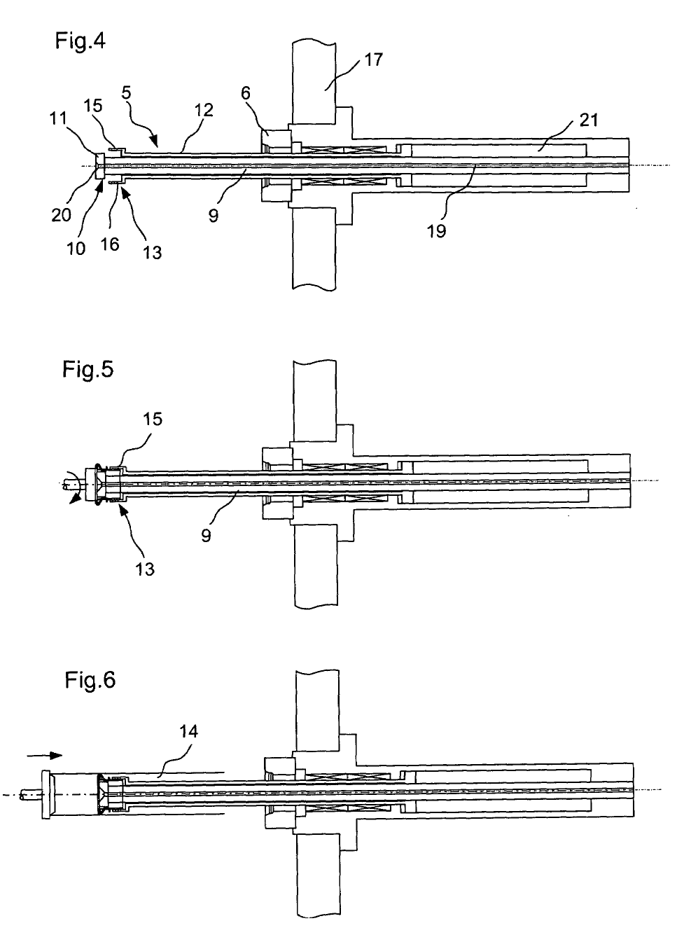

FIG. 4 shows a longitudinal section through a fabrication unit according to the invention.

FIG. 5 shows the fixing of the assembly of FIG. 3 to the fabrication unit.

FIG. 6 shows the loading of a tubular body.

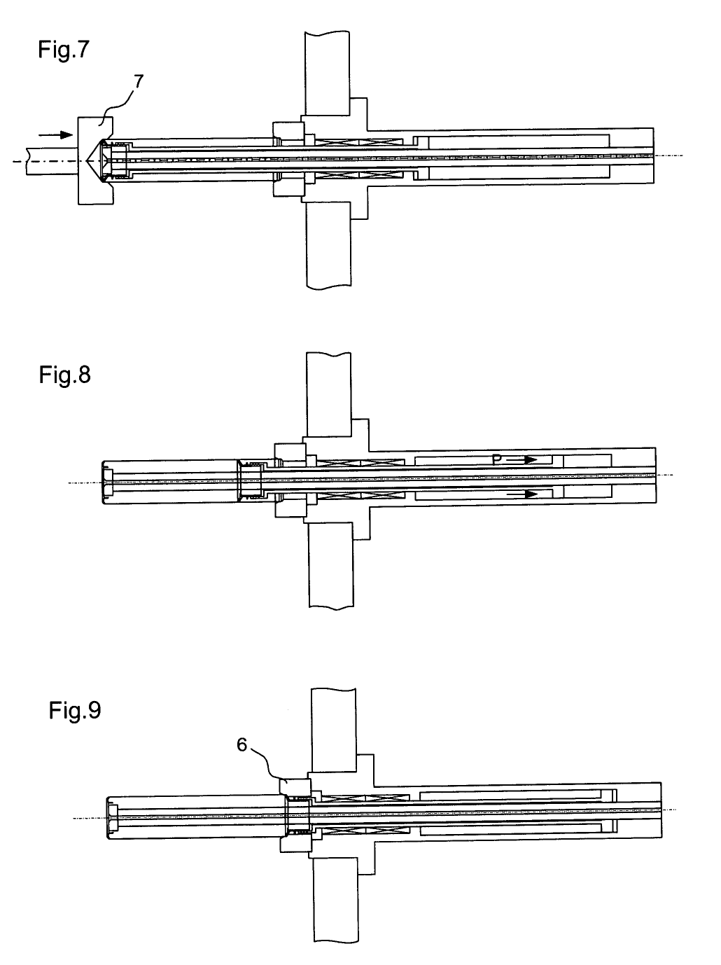

FIG. 7 shows the welding of the base to the tubular body.

FIG. 8 shows the movement of the top part towards its end position.

FIG. 9 shows the welding of the top part to the tubular body.

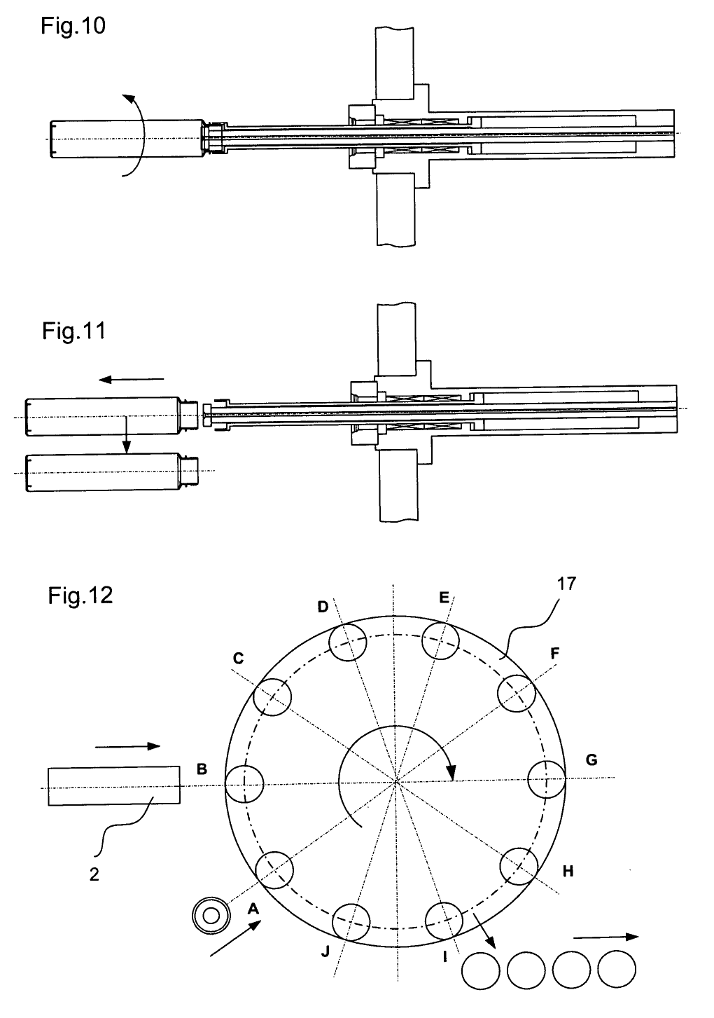

FIG. 10 shows the start of the withdrawal of a container from the fabrication unit.

FIG. 11 shows the end of the withdrawal of a container from the fabrication unit.

FIG. 12 is a simplified front view of a rotating plate containing a plurality of fabrication units.

### LIST OF NUMERICAL REFERENCES

1. Tubular container
2. Tubular body
3. Rigid base
4. Top part
5. Mandrel
6. Element for fixing the top part to the tubular body
7. Element for fixing the base to the tubular body
8. Neck
9. Support shaft
10. Free end of the support shaft
11. Retaining member
12. Tubular sleeve
13. Free end of the tubular sleeve
14. Space for receiving a tubular body
15. Top part grip member
16. Top part fixing element
17. Rotating plate
18. Mechanism for fixing the base to the top part
19. Fluid passage
20. Intake/outlet aperture
21. Space for containing fluid

FIG. 1 shows the three components of a container 1 which can be used with the device according to the invention, namely a flexible tubular body 2, for example a laminated tube, a rigid base 3 and a top part 4 including a neck 8. In a first step, the base 3 is fixed to the top part 4 by means of a snap-fit mechanism 18 (see FIG. 3). Clearly, any other instantaneous fixing system can be used. In a variant of the invention which is not shown, the top part and the base are initially fabricated in one piece by injection, the two elements being subsequently separated during the fabrication process, for example by the breaking of temporary links. As described below, the base 3 is then separated from the top part 4 during the fabrication process. FIG. 2 shows a container 1 in its configuration at the end of the fabrication process. The base 3 has been welded to the lower end of the tubular body 2, and the top part 4 has been welded to the upper end of the tubular body 2.

FIG. 4 shows a fabrication unit fixed to a rotating plate 17 (see FIG. 12). The unit consists of a support shaft 9 surrounded by a sleeve 12 mounted slidably on the support shaft 9 and having a free end 13 provided with a member 15 for gripping and fixing a top part 4. The support shaft 9 has an internal passage 19 for directing a fluid, preferably a gas, towards or from the free end 10 of the support shaft 9. The free end 10 of the support shaft 9 has a retaining member 11 which has an aperture 20 through which the internal passage 19 opens. The geometry of the aperture 20 (preferably a flared cone) is chosen to ensure that the base 3 adheres well by suction to the retaining member 11.

On the rotating plate 17, a top part fixing element 6 comprising a heating system, of the HF type for example, surrounds the assembly consisting of the support shaft 9 and the sleeve 12.

FIGS. 5 to 11 show different steps in the fabrication of a container 1 by means of the fabrication unit shown in FIG. 1.

In a first step (see FIG. 5), an assembly consisting of a top part 4 and a base 3 is fixed to the free end 13 of the sleeve 12. The fixing is carried out by screwing the neck of the top part into a screw thread 16.

In a second step (see FIG. 6), a tubular body 2 is fitted around the sleeve 12. A space 14 is provided for this purpose. It should be noted that, at the end of this step, the assembly consisting of a top part 4 and a base 3 is positioned in the lower part of the tubular body 2 (on the left-hand side of the figure).

In a third step (FIG. 7), a welding system 7 is positioned near the lower end of the tubular body 2 and the base 3 is welded to the tubular body 2.

In a fourth step (FIG. 8), the sleeve 12 is moved towards the upper end of the tubular body 2. This operation causes the movement of the top part 4 which is fixed to the sleeve 12, but does not cause any movement of the base which remains in place because of the retaining member 11.

In a variant of the invention (not shown), the fourth step takes place before the third step.

In a fifth step (FIG. 9), when the top part 4 has reached its final position with respect to the tubular body 2, it is welded to the latter by means of the fixing element 6 which includes a welding system.

In a sixth step (FIG. 10), the top part 4 is unscrewed from the sleeve 12.

Finally (FIG. 11), the container 1 is withdrawn from the fabrication unit.

FIG. 12 shows a schematic view of a rotating plate containing a plurality of fabrication units. The fabrication units are grouped in stations, each station executing one of the six steps described above.

In the illustrated example, two tubular bodies 2 are loaded simultaneously on to the rotating plate 17.

In FIG. 12, each station is represented by a letter, according to the following list:

A Loading of top part/rigid base
B Loading of tubular body
C Positioning of tubular body
D Pre-treatment of the base with hot air
E High-frequency welding of the base
F High-frequency welding of the top part
G High-frequency welding of the top part
H High-frequency welding of the top part
I Discharge of the container
J Free station (discharge monitoring)

1. Device for fabricating tubular containers made from plastics material and consisting of three distinct elements, namely:
a flexible tubular body,
a rigid base,
a top part including a neck,
the said device comprising a mandrel and means for fixing a top part and a base to a flexible tubular body, characterized in that it consists of at least one fabrication unit comprising a support shaft having a free end provided with a retaining member adapted to prevent the movement of a container base in one direction, a tubular sleeve mounted slidably around the support shaft and having a free end located on the same side as the free end of the support shaft, a member for driving the tubular sleeve in a linear way, and a space adapted for the relative movement of a tubular body around the tubular sleeve, the said tubular sleeve additionally comprising a top part grip member located near the free end of the sleeve, the said top part grip member comprising means for the instantaneous fixing and retention of an assembly consisting of a top part and a base of a container.

2. Device according to claim 1, in which the instantaneous fixing and retaining means consist of a screw thread.

3. Device according to claim 1, characterized in that the member for driving the tubular sleeve is of the pneumatic type.

4. Device according to claim 1, comprising a plurality of adjacent fabrication units positioned along a circle.

5. Device according to claim 4, comprising an element in the form of a rotating plate including a set of fabrication units positioned along a direction perpendicular to the plane of the rotating plate.

6. Device according to claim 5, comprising a plurality of operating stations, each station consisting of at least one fabrication unit.

7. Assembly made from plastics material, consisting of a rigid base and a top part including a neck, the said assembly being adapted to be used with the device according to any one of the preceding claims, characterized in that the rigid base includes a part for contacting a retaining member, and in that the top part includes a part to be gripped by a gripping member, the said assembly also comprising fixing means adapted to fix the base instantaneously to the top part or vice versa.

8. Assembly according to claim 7, characterized in that the fixing means are of the snap-fit type.

9. Method for fabricating tubular containers made from plastics material and consisting of three distinct elements, namely:
a flexible tubular body,
a rigid base,
a top part including a neck,
the said method comprising the following successive steps:
fixing a top part to the free end of a tubular sleeve mounted slidably on a support shaft,
fixing a base to a retaining member positioned on the free end of the support shaft,
fitting a tubular body around the tubular sleeve,
welding the base to the tubular body,
retaining the base and driving the top part by moving the tubular sleeve towards the end of the body opposite the end where the base is located,
welding the top part to the tubular body,
withdrawing the container from the assembly consisting of the support shaft and the tubular sleeve.

10. Method according to claim 9, characterized in that the base is fixed to the top part.

11. Method according to claim 9, characterized in that the base is fixed to the retaining member.

12. Method according to claim 11, in which the base is fixed by suction to the retaining member.

13. Method of fabricating tubular containers made from plastics material and consisting of three distinct elements, namely:
a flexible tubular body,
a rigid base,
a top part including a neck,
the said method comprising the following successive steps:
fixing the rigid base to the top part,
fixing the assembly consisting of the top part and base to the free end of a tubular sleeve mounted slidably on a support shaft,
fitting a tubular body around the tubular sleeve,
welding the base to the tubular body,
retaining the base and driving the top part by moving the tubular sleeve towards the end of the body opposite the end where the base is located,
welding the top part to the tubular body,
withdrawing the container from the assembly consisting of the support shaft and the tubular sleeve.
